(19) United States
(12) Patent Application Publication
(10) Pub. No.: US 2019/0205233 A1
(43) Pub. Date: Jul. 4, 2019

(54) FAULT INJECTION TESTING APPARATUS AND METHOD

(71) Applicants: Hyundai Motor Company, Seoul (KR); Kia Motors Corporation, Seoul (KR); Suresoft Technologies Inc., Seoul (KR)

(72) Inventors: Yoonsik Jung, Seoul (KR); KwangChul Jeong, Bucheon (KR); Kyung-Hwa Choi, Seoul (KR); Seung-Uk Oh, Seoul (KR); Yon-Soo Jong, Seoul (KR); Hyun-Seop Bae, Seoul (KR)

(21) Appl. No.: 15/992,944

(22) Filed: May 30, 2018

(30) Foreign Application Priority Data
Dec. 28, 2017 (KR) 10-2017-0181790

(51) Int. Cl. G06F 11/263

(52) U.S. Cl. CPC G06F 11/263

(57) ABSTRACT

A fault injection testing apparatus can include: a communication module communicating with an electronic control device; a test scenario management module creating a test scenario for performing a fault injection test on the electronic control device; a test run module running the fault injection test according to the test scenario and transmitting fault data to the electronic control device; a fault detection module determining whether the fault data is normally transmitted to the electronic control device from the test run module; and a recovery determination module determining whether the electronic control device recovers from a fault introduced to the electronic control device through the fault data transmitted from the test run module.

### CROSS-REFERENCE TO RELATED APPLICATION

This application is based on and claims the benefit of priority under 35 U.S.C. § 119 to Korean Patent Application No. 10-2017-0181790, filed on Dec. 28, 2017 in the Korean Intellectual Property Office, the disclosure of which is incorporated herein by reference in its entirety.

### BACKGROUND

### 1. Technical Field of the Disclosure

The present disclosure relates to a fault injection testing apparatus and method and, more particularly, to a fault injection testing apparatus and method for determining whether a fault is normally injected while a fault injection test is performed on an electronic control device equipped in a vehicle and whether recovery from the injected fault is made according to a valid standard.

### 2. Discussion of Related Art

An increasing number of electronic control devices, e.g., Electronic Control Units (ECUs), have recently been implemented in vehicles for handling various functions. However, the reliability of software (S/W) embedded in the electronic control devices is being questioned due to accidents caused by malfunctioning electronic control devices. Accordingly, ISO 26262 standards define that functional safety requirements applied for other areas (e.g., train, airline, or nuclear power industry) should be applied for the automotive industry, and that software elements of the electronic control devices should be tested using a fault injection test.

The electronic control devices are generally designed to avoid and prevent faults, and need to have mechanisms for detecting errors and self-recovering from the errors within a short period even if an unexpected fault occurs. Therefore, before the electronic control device is actually installed in the vehicle, a need exists to forcedly introduce a fault to the electronic control device and verify whether detection of the fault, and recovery from the fault, are normally performed.

Conventionally, electronic control devices have been checked to determine whether they operate without any special problem by monitoring a state of the electronic control device before and after fault injection. However, the devices are not checked to determine whether the fault was normally injected, nor whether recovery from the fault was made according to a valid procedure and standard, thus decreasing the reliability of the fault injection test. Moreover, since a designer is required to directly inject the fault to an electronic control device (e.g., using a “debugger” instruction), observe a state of the electronic control device, and then make a report on the result, it is inefficient in terms of time and cost.

### SUMMARY OF THE DISCLOSURE

The present disclosure provides a fault injection testing apparatus and method by which it can be determined whether a fault is normally introduced and whether recovery from the fault is made according to a predefined procedure and standard during a fault injection test on an electronic control device.

The present disclosure also provides a fault injection testing apparatus and method by which a fault injection test on an electronic control device may be automatized by automatically performing the fault injection test and automatically making the test result report.

According to embodiments of the present disclosure, a fault injection testing apparatus may comprise: a communication module communicating with an electronic control device; a test scenario management module creating a test scenario for performing a fault injection test on the electronic control device; a test run module running the fault injection test according to the test scenario and transmitting fault data to the electronic control device; a fault detection module determining whether the fault data is normally transmitted to the electronic control device from the test run module; and a recovery determination module determining whether the electronic control device recovers from a fault introduced to the electronic control device through the fault data transmitted from the test run module.

The fault injection testing apparatus may further comprise a monitoring module monitoring a state of the electronic control device when the fault injection test is started.

The fault injection testing apparatus may further comprise a report making module making a test result report, when the fault injection test is completed, including state information of the electronic control device and analysis information about a change in a state of the electronic control device before and after the transmission of the fault data.

The test scenario may comprise a test run condition, the fault data to be transmitted to the electronic control device, a fault detection standard, and a recovery determination standard.

The test run condition may comprise a target task to which a fault is to be introduced, a point in time to transmit the fault data, and a fault data transmission repeat condition.

The fault data may correspond to a fault type among a plurality of predetermined fault types comprising task run interruption, prevention of task rerun by a scheduler, prevention of task rerun through interruption of alarming, prevention of task rerun after waiting for an event, prevention of task rerun by inducing deadlock while waiting for a resource, prevention of task rerun by inducing stack overflow, task overrun, variable value contamination, code change, CPU register value contamination, software component contamination, and a bit flip.

The fault detection module may determine that the fault data is normally transmitted when the fault is detected based on a fault detection standard that determines whether the fault affects at least one of a task run count value, an alarm cycle value, an error code value, a data value of a particular memory area, an entire system operation, and a task running time.

The recovery determination module may determine whether the electronic control device recovers from the fault based on a recovery determination standard that determines whether the electronic control device recovers from the fault affecting at least one of a task run count value, an alarm cycle value, an error code value, a data value of a particular memory area, an entire system operation, and a task running time is made.

The monitoring module may output a graph indicating changes in a task state and a graph indicating changes in a variable value of the electronic control device, resulting from a fault injection test run.

The test scenario management module may create a test scenario to suit characteristics of the electronic control device based on setting information of the electronic control device received through the communication module.

The point in time to transmit fault data may be determined according to a number of times a predetermined target task is run or a waiting time after the fault injection test has started.

The recovery determination module may determine that the electronic control device fails to recover from the fault when recovery from the fault is not made within a recovery permission period.

Furthermore, according to embodiments of the present disclosure, a fault injection testing method may comprise: establishing a communication session with an electronic control devices using a communication module; receiving design information of the electronic control device via the established communication session; creating a test scenario for performing a fault injection test on the electronic control device; running the fault injection test according to the test scenario; transmitting fault data to the electronic control device; determining whether the fault data is normally transmitted to the electronic control device; and determining whether the electronic control device recovers from a fault introduced to the electronic control device through the transmitted fault data.

The fault injection testing method may further comprise monitoring a state of the electronic control device when the fault injection test is started.

The fault injection testing method may further comprise, when the fault injection test is completed, making a test result report including state information of the electronic control device and analysis information about a change in a state of the electronic control device before and after the transmission of the fault data.

The test scenario may comprise a test run condition, the fault data to be transmitted to the electronic control device, a fault detection standard, and a recovery determination standard.

The test run condition may comprise a target task to which a fault is to be introduced, a point in time to transmit the fault data, and a fault data transmission repeat condition.

The fault data may correspond to a fault type among a plurality of predetermined fault types comprising task run interruption, prevention of task rerun by a scheduler, prevention of task rerun through interruption of alarming, prevention of task rerun after waiting for an event, prevention of task rerun by inducing deadlock while waiting for a resource, prevention of task rerun by inducing stack overflow, task overrun, variable value contamination, code change, CPU register value contamination, software component contamination, and a bit flip.

The determining of whether the fault data is normally transmitted may comprise determining that fault data is normally transmitted when the fault fault is detected based on a fault detection standard that determines whether the fault affects at least one of a task run count value, an alarm cycle value, an error code value, a data value of a particular memory area, an entire system operation and a task running time.

The determining of whether the electronic control device recovers from the fault may comprise determining whether the electronic control device recovers from the fault based on a recovery determination standard that determines whether the electronic control device recovers from the fault affecting at least one of a task run count value, an alarm cycle value, an error code value, a data value of a particular memory area, an entire system operation and a task running time.

The monitoring of the state of the electronic control device may comprise outputting a graph indicating changes in a task state and a graph indicating changes in a variable value of the electronic control device, resulting from a fault injection test run.

The creating of the test scenario may comprise creating a test scenario to suit characteristics of the electronic control device based on setting information of the electronic control device.

The point in time to transmit fault data may be determined according to a number of times a predetermined target task is run or a waiting time after the fault injection test has started.

The determining of whether the fault recovery is made may comprise determining that the electronic control device fails to recover from the fault when recovery from the fault is not made within a recovery permission period.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram of a fault injection testing system, according to embodiments of the present disclosure;

FIG. 2 shows internal configurations of a fault injection testing apparatus and an electronic control device, according to embodiments of the present disclosure;

FIG. 3 shows a sequence of an entire flow of a fault injection testing method, according to embodiments of the present disclosure;

FIG. 4 is a view for explaining how a fault injection testing apparatus creates a test scenario, according to embodiments of the present disclosure;

FIG. 5 shows an example of a fault injection testing apparatus monitoring and outputting a state of an electronic control device, according to embodiments of the present disclosure;

FIG. 6 shows an example of a fault injection testing apparatus making a test result report, according to embodiments of the present disclosure; and

FIGS. 7 to 12 are flowcharts illustrating a fault injection testing method, according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Like numerals refer to like elements throughout the specification. Not all elements of embodiments of the present disclosure will be described, and description of what are commonly known in the art or what overlap each other in the embodiments will be omitted. The terms as used throughout the specification, such as “˜part”, “˜module”, “˜member”, “˜block”, etc., may be implemented in software and/or hardware, and a plurality of “˜parts”, “˜modules”, “˜members”, or “˜blocks” may be implemented in a single element, or a single “˜part”, “˜module”, “˜member”, or “˜block” may include a plurality of elements.

It will be further understood that the term “connect” or its derivatives refer both to direct and indirect connection, and the indirect connection includes a connection over a wireless communication network.

The term “include (or including)” or “comprise (or comprising)” is inclusive or open-ended and does not exclude additional, unrecited elements or method steps, unless otherwise mentioned.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is to be understood that the singular forms “a,” “an,” and “the” include plural references unless the context clearly dictates otherwise.

Additionally, it is understood that one or more of the below methods, or aspects thereof, may be executed by at least one control unit. The term “control unit” may refer to a hardware device that includes a memory and a processor. The memory is configured to store program instructions, and the processor is specifically programmed to execute the program instructions to perform one or more processes which are described further below. The control unit may control operation of units, modules, parts, or the like, as described herein. Moreover, it is understood that the below methods may be executed by an apparatus comprising the control unit in conjunction with one or more other components, as would be appreciated by a person of ordinary skill in the art.

Furthermore, the control unit of the present disclosure may be embodied as non-transitory computer readable media containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

Reference numerals used for method steps are just used for convenience of explanation, but not to limit an order of the steps. Thus, unless the context clearly dictates otherwise, the written order may be practiced otherwise.

The principle and embodiments of the present disclosure will now be described with reference to accompanying drawings.

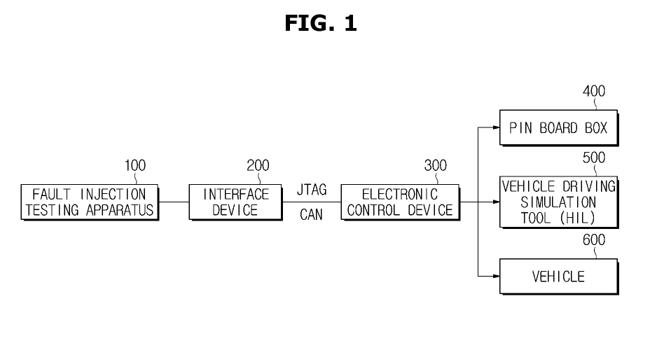

FIG. 1 is a block diagram of a fault injection testing system, according to embodiments of the present disclosure.

As shown in FIG. 1, a fault injection testing system includes a fault injection testing apparatus 100, an interface device 200, and an electronic control device 300.

The fault injection testing apparatus 100 may be a device or terminal such as a computer, a laptop, a tablet, a smart phone, or the like that includes a data handling processor, i.e., a central processing unit (CPU), and a memory. A computer program or application for performing a fault injection test may be loaded in the fault injection testing apparatus 100.

The interface device 200 may be a device for connecting the fault injection testing apparatus 100 and the electronic control device 300, which may be a debugger or a communication adapter. The fault injection testing apparatus 100 may use the interface device 200 to access a processor, a register, or a memory of the electronic control device 300. The fault injection testing apparatus 100 may send fault data to the electronic control device 300 and receive information about a state of the electronic control device 300 through the interface device 200.

The interface device 200 and the electronic control device 300 may exchange data through Controller Area Network (CAN) communication. If the interface device 200 is a debugger, it may be connected to the electronic control device 300 through the Joint Test Action Group (JTAG) interface. The fault injection testing apparatus 100, the interface device 200, and the electronic control device 300 may be connected to one another wiredly or wirelessly.

The electronic control device 300 may be an electronic control unit (ECU) for vehicle. The electronic control device 300 is not, however, limited for vehicles but may be applied for other products in different industries. For example, the electronic control device 300 may be a remote terminal unit (RTU) that is used in the power system. However, for convenience of explanation, it is assumed herein that the electronic control device 300 is for vehicles.

In a case that the electronic control device 300 is not connected to a vehicle driving simulation tool 500 or a vehicle 600, a pin board box 400 is required to supply electric power to the electronic control device 300 for the fault injection testing device 100 to perform a fault injection test on the electronic control device 300.

The fault injection testing apparatus 100 may perform the fault injection test even when the electronic control device 300 is connected to the vehicle driving simulation tool 500 or the vehicle 600. In other words, the fault injection testing apparatus 100 may perform the fault injection test to suit the situation the electronic control device 300 is connected to. That is, it is possible to build an infrastructure to perform a fault injection test not only on an unfixed electronic control device but also on an electronic control device connected to a vehicle driving simulation tool, e.g., Hardware-in-the-loop (Hit), or to a vehicle.

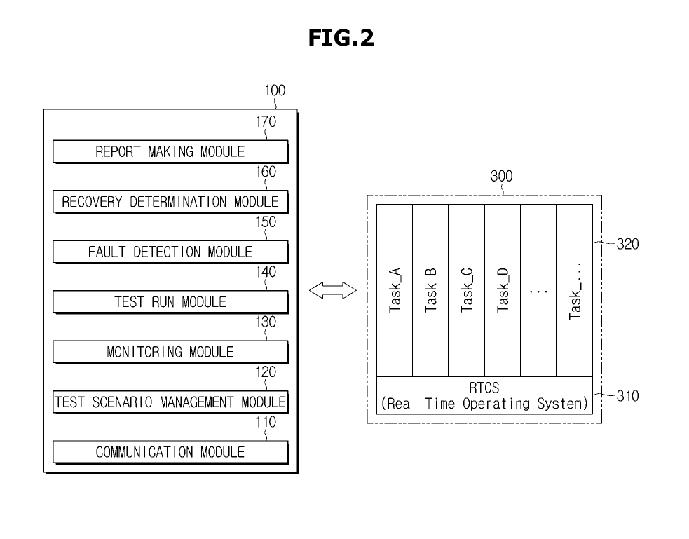

FIG. 2 shows internal configurations of a fault injection testing apparatus and an electronic control device, according to embodiments of the present disclosure.

As shown in FIG. 2, the fault injection testing apparatus may include a communication module 110 and a control unit (not shown) for performing a fault injection test, and the control unit may include a test scenario management module 120, a monitoring module 130, a test run module 140, a fault detection module 150, a recovery determination module 160, and a report making module 170.

The control unit may include a processor, as explained hereinabove, that runs a fault injection test and processes data generated in the test procedure. The fault injection testing apparatus 100 may operate based on an operating system, such as Windows, Linux, Mac, Android, etc.

Although the modules that constitute the control unit will be focused in the following description, functions performed by the respective modules should be understood as being performed in a single control unit.

The communication module 110 is a module to establish a communication session and perform communication with the electronic control device 300. The communication module 110 sends fault data generated by the test scenario management module 120 to the electronic control device 300 according to a test run instruction from the test run module 140 and receives state information from the electronic control device 300. The state information of the electronic control device 300 includes task run information and variable value information.

The test scenario management module 120 creates a test scenario to perform a fault injection test on the electronic control device 300. The test scenario includes a test run condition, fault data to be transmitted to the electronic control device 300, fault detection standard information, and recovery determination standard information.

The test scenario management module 120 may create a test scenario that suits the characteristics of the electronic control device 300 by analyzing setting information of the electronic control device 300 received through the communication module 110.

The setting information of the electronic control device 300 is information unique to the electronic control device 300, and may be obtained from ‘*.oil’ file including design information of the electronic control device 300 or ‘*.map’ file including address or symbol information if the electronic control device 300 has the OSEK/VDX operating system. If the electronic control device 300 has other operating system than the OSEK/VDX operating system, the setting information of the electronic control device 300 may be defined by other type of file or a source code itself.

The test scenario management module 120 may analyze the setting information of the electronic control device 300 to extract all types of fault that are likely to occur in the electronic control device 300.

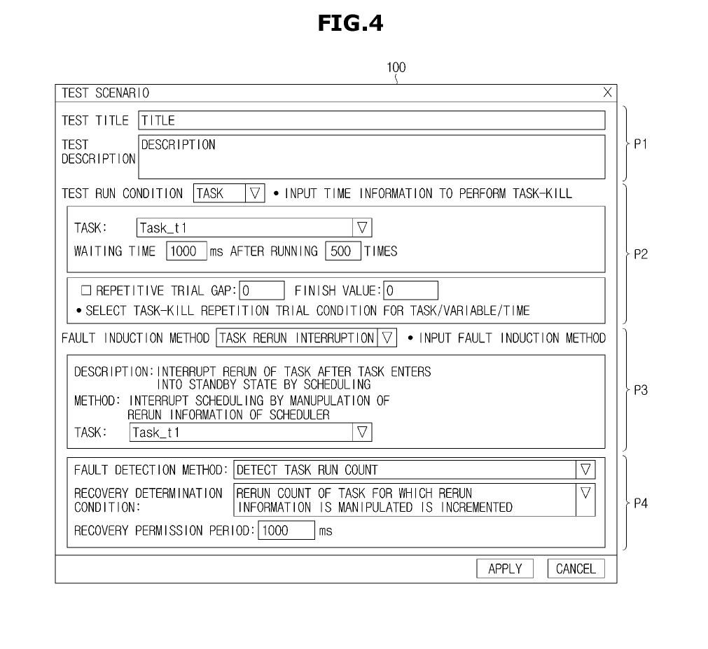

The fault data refers to data for artificially inducing a fault on the electronic control device 300. The fault data is determined depending on the fault type. Creation of a test scenario will be described in detail in connection with FIG. 4.

The monitoring module 130 monitors the state of the electronic control device 300 once a fault injection test is started. For example, the monitoring module 130 outputs the state information of the electronic control device 300 received through the communication module 110 on a display of the fault injection testing apparatus 100. The monitoring module 130 may output graphs of changes in task state and variables of the electronic control device 300 on the display.

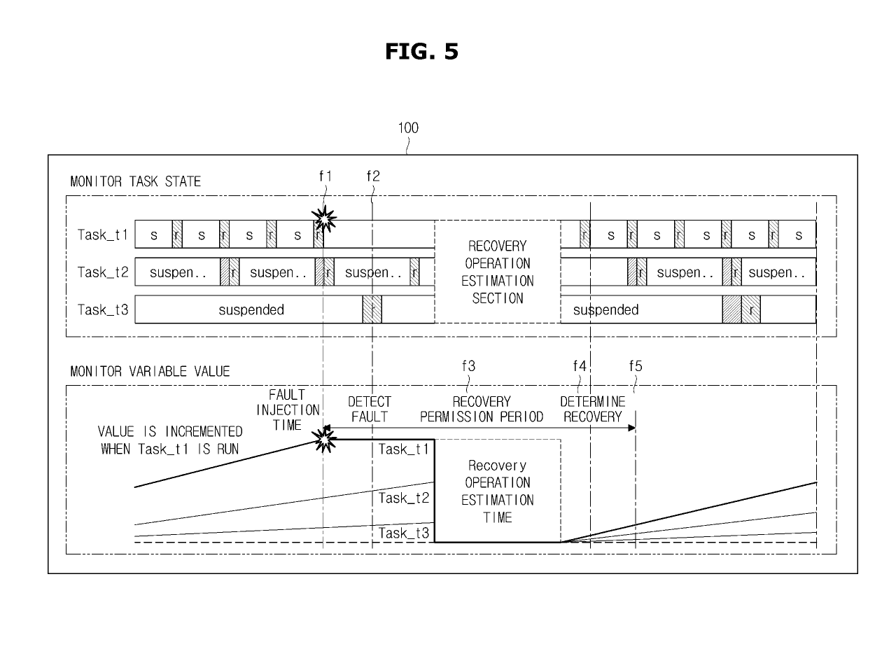

Referring now to FIG. 5, changes in task state monitored on the display of the fault injection testing apparatus 100 may be output in the form of a bar graph, and changes in variables may be output in the form of a graph of broken line.

The monitoring module 130 may determine whether the electronic control device 300 is normally operating based on the state information of the electronic control device 300 when the fault injection test is started. The monitoring module 130 monitors the state of the electronic control device 300 in real time from start to finish of the fault injection test.

The test run module 140 runs the fault injection test according to the test scenario created by the test scenario management module 120. The test run module 140 sends fault data to the electronic control device 300 through the communication module 110. The fault data may be sent to the electronic control device 300 at a particular point in time or repeatedly according to a test run condition. For example, the test run condition may include a target task to which a fault is to be introduced, a point in time to send the fault data, and a fault data transmission repeat condition.

The fault detection module 150 determines whether the fault data has been normally sent to the electronic control device 300. When the fault data is normally sent to the electronic control device 300, a fault occurs in the electronic control device 300 due to the fault data. The fault detection module 150 may detect the fault and determine that the fault data has been normally sent to the electronic control device 300. The fault detection module 150 detects a fault based on the fault detection standard information included in the test scenario.

The recovery determination module 160 may determine whether the electronic control device 300 has recovered from the fault. Whether recovery from the fault is made may be determined based on the recovery determination standard information included in the test scenario.

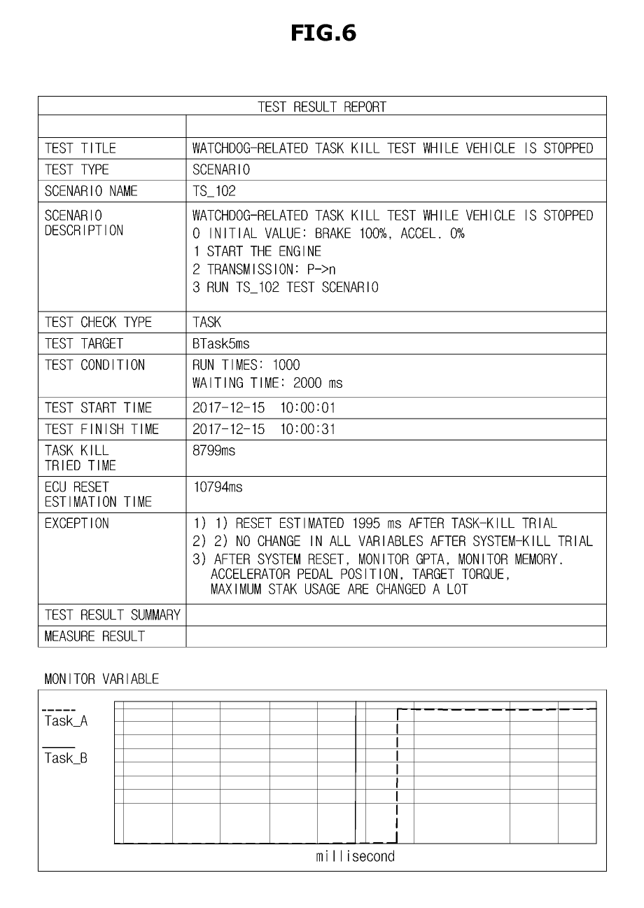

When the fault injection test is completed, the report making module 170 makes a test result report including state information of the electronic control device 300 and analysis information about a change in state of the electronic control device 300 before and after the fault data is sent to the electronic control device 300. FIG. 6 shows an example of a test result report. The test result report may be made in various forms and provided in a file format.

The electronic control device 300 includes an operating system 310 and a plurality of tasks 320 (see FIG. 2). The operating system 310 may be the Real Time Operating System (RTOS). The operating system 310 is not, however, limited to the RTOS, but is assumed herein to be the RTOS because the electronic control device 300 is assumed to be one for vehicles in describing embodiments of the present disclosure. Many different operating systems may be used.

The RTOS offers an environment to be able to perform a given process in a set period of time. Each process operates in the unit of task 320, and the task 320 has four states: running, suspended, waiting, and ready. Furthermore, since the tasks 320 may be run one at a time, all the tasks 320 are managed by a scheduler and run in the order of priority.

A task is a basic unit of software made in the RTOS. That is, the RTOS may be called a process, and the task may be called a thread. When the electronic control device 300 is powered on, a huge process called the RTOS operates and a thread called the task operates.

As a representative example of the RTOS, there is the OSEK/VDX used in embedded areas. The OSEK/VDK includes elements as listed in the following table 1. The fault injection testing apparatus 100 may artificially introduce a fault to the electronic control device 300 by using the elements shown below in Table 1.

TABLE 1

| | |
|---|---|
| Task | Most basic operation unit of the RTOS |
| Interrupt | Used in handling hardware mechanisms and |
| | asynchronous events |
| Resource | Used in sharing a resource between tasks |
| Alarm | Able to periodically run the task |
| Event | Synchronize tasks based on an event signal |
| Message | Used in sending data between tasks |

In the meantime, the operating system 310 of the electronic control device 300 is not essential. The electronic control device 300 may operate in firmware without any operating system.

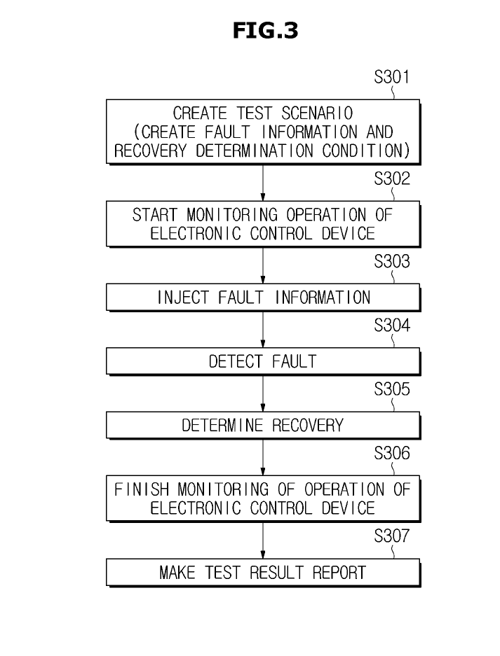

FIG. 3 shows a sequence of an entire flow of a fault injection testing method, according to embodiments of the present disclosure. As shown in FIG. 3, the fault injection testing apparatus 100 creates a test scenario for a fault injection test, in S301. The test scenario includes a test run condition, fault data to be sent to the electronic control device 300, a fault detection standard, and a recovery determination standard.

The fault injection testing apparatus 100 monitors operation of the electronic control device 300 once a fault injection test is started, in S302. If it is determined that the electronic control device 300 is in a normal state, the fault injection testing apparatus 100 sends fault data for inducing a fault to the electronic control device 300, in S303.

As described above, the fault data refers to data for artificially introducing a fault to the electronic control device 300 and is determined by a type of fault.

The type of fault may be divided into task run interruption, prevention of task rerun by the scheduler, prevention of task rerun through interruption of alarming, prevention of task rerun after waiting for an event, prevention of task rerun by inducing deadlock while waiting for a resource, prevention of task rerun by inducing stack overflow, task overrun, variable value contamination, code change, CPU register value contamination, software component contamination, or bit flip.

TABLE 2

| | | Description of the type of fault and fault |
|---|---|---|
| number | Type of fault | introduction method |
| 1 | Task run interruption | Forcedly interrupt a running task |
| | | → Manipulate instruction pointer: induce |
| | | malfunction of a running task |
| 2 | Prevention of task | Interrupt rerun of the task after the task enters |
| | rerun by a scheduler | into a standby state by the scheduler→ Change |
| | | ‘Active_count’ value to induce malfunction of |
| | | the running task |
| 3 | Prevention of task | Interrupt run of a task that runs periodically by |
| | rerun through | alarm |
| | interruption of | → Manipulate alarm cycle to interrupt run of the |
| | alarming | task |
| 4 | Prevention of task | Put the task into a state of waiting an event and |
| | rerun after waiting for | interrupt rerun of the task |
| | an event | → Manipulate waiting event mask to interrupt |
| | | rerun |
| 5 | Prevention of task | Interrupt run of other task waiting for release of a |
| | rerun by inducing | resource by interrupting the release of the |
| | deadlock while waiting | resource of the task that uses the resource |
| | for a resource | → Manipulate a resource ID to interrupt normal |
| | | operation of the task |
| 6 | Prevention of task | Induce overflow by making the stack of a |
| | rerun by inducing stack | running task full |
| | overflow | → Induce malfunction of the entire system by |
| | | allocating a maximum value to the stack pointer |
| 7 | Task overrun (inducing | Delay the task run time later than expected |
| | omission or delay other | → Transfer to other function that has long run |
| | task) | time while the task is running (next task to run is |
| | | omitted or delayed by the delayed task) |
| | | Induce task omission exclusive of task overrun |
| | | → Place a higher priority on a task with long run |
| | | time than on a task with short run time |
| 8 | Variable value | Change the value of a particular variable to an |
| | contamination | arbitrary value (within or out of a range) |
| | | → Change the value of a particular variable by |
| | | referring to a map file |
| 9 | Code change | Change the value of a code in a code area to an |
| | | arbitrary value |
| | | → Change the value of a code in a code address |
| | | area by referring to a map file |
| 10 | CPU register value | Change the value of a register to an arbitrary |
| | contamination | value |
| | | → Change the value of a register |
| 11 | Software component | Identify the software component and change |
| | contamination | information such as Event, Runable, etc. |
| | | → Change Event setting information, change |
| | | Runable function address |
| 12 | Bit Flip | Change a bit of an arbitrary memory area |
| | | → Change the value of a particular memory in |
| | | bits |

After sending the fault data, the fault injection testing apparatus 100 detects a fault according to the fault detection standard to determine whether the fault data has been normally sent, in S304. The fault injection testing apparatus 100 may determine that the fault data has been normally sent if the fault is detected, based on the fault detection standard that determines whether a fault occurs to at least one of a task run count value, an alarm cycle value, an error code value, a data value of a particular memory area, the entire system operation and task running time.

Table 3 represents targets for detection and fault detection standards. The target for detection refers to an object that is expected to have a fault due to the fault data.

TABLE 3

| | Target for | | Corresponding |
|---|---|---|---|
| number | detection | Fault detection standard | fault type |
| 1 | Task run | Detect a fault if the task run count value | 1, 2, 3, 4, 5, 11 |
| | count | is not incremented | |
| 2 | Alarm | Detect a fault if the alarm cycle value is | 3 |
| | information | changed to ‘0’ | |
| 3 | Function run | If a situation occurs in which a designed | 8, 9 |
| | results | function is not normally operating during | |
| | | running of a program, running of the | |
| | | function is stopped and the error code | |
| | | value is returned, in which case if the | |
| | | error code value is not a normal value a | |
| | | fault is detected. | |
| 4 | Memory area | Detect a fault if fault data that induces the | 1, 2, 3, 4, 5, 8, |
| | | fault is included in a particular memory | 9, 10, 11, 12 |
| | | area inside the electronic control device | |
| 5 | System | If a phenomenon occurs that the RTOS of | 6 |
| | operation | the electronic control device is not | |
| | | running but frozen (in a case that | |
| | | operation of all the tasks is stopped and | |
| | | an error occurs to debugger connection) | |
| 6 | Task run time | Collect average run time of each task and | 7 |
| | | detect a fault if the task run time is out of | |
| | | the margin of error of the average run | |
| | | time | |

The task run count value is a count value of a particular task, which is incremented once the task is run by the scheduler

The alarm cycle value refers to a repetition cycle of alarming. The alarm is automatically activated when a designated Tick is reached by the counter. When the alarm is activated, a designated action (connected to a task or alarm-callback function) is performed.

The error code refers to a code allocated to a problem that arises when a designed function is not working as expected. Most programs allocate type-specific codes. The error code gives an error code vale if a situation is detected in which a designed function is not operating normally as designed, and the program stops running.

The fault types that induce a fault to the six types of target for detection as represented in table 3 are as follows: among the fault types represented above in Table 2, fault types that induce a fault to the task run information are Nos. 1, 2, 3, 4, 5, and 11; a fault type that induces a fault to the alarm information is No. 3; fault types that induce a fault to the function run result are Nos. 8 and 9; fault types that induce a fault to a memory area are Nos. 1, 2, 3, 4, 5, 8, 9, 10, 11, and 12; a fault type that induces a fault to the system operation is No. 6; and a fault type that induces a fault to the task run time is No. 7.

When a fault occurs to the electronic control device 300 due to the fault data, the electronic control device 300 automatically recovers from the fault. In this regard, the fault injection testing apparatus 100 determines whether the electronic control device 300 recovers from the fault based on a valid procedure and standard, according to the recovery determination standard, in S305.

The fault injection testing apparatus 100 may determine whether the fault recovery is made based on the recovery determination standard that determines whether the recovery from a fault occurring to at least one of the task run count value, the alarm cycle value, the error code value, the data value of a particular memory area, the entire system operation and the task running time is made. Table 4 represents recovery determination standards.

TABLE 4

| | Target for | |
|---|---|---|
| number | detection | Recovery determination standard |
| 1 | Task run | Determine that recovery from a fault is made if the task run |
| | count | count value is incremented again |
| 2 | Alarm | Determine that recovery from a fault is made if the alarm |
| | information | cycle value is restored to one before the fault data was |
| | | introduced |
| 3 | Function | Determine that recovery from a fault is made when an error |
| | run results | code expected to be troubled from a fault is restored to a |
| | | normal value after the error code is monitored and the fault |
| | | data is input |
| 4 | Memory | Determine that recovery from a fault is made when data of a |
| | area | particular memory area is restored to one before fault data |
| | | was input or one in a range of data values to be determined |
| | | as being normal after the memory area is monitored and the |
| | | fault data is input. |
| 5 | System | Determine that recovery from a fault is made when the RTOS |
| | operation | is normally operating again (if the debugger connection is |
| | | normalized and the task is normally operating) |
| 6 | Task run | Determine that recovery from a fault is made when the task |
| | time | run time is restored into the margin of error of the average |
| | | run time |

The fault injection testing apparatus 100 checks the fault detection result and the fault recovery result and then stops monitoring the electronic control apparatus 300 in S306 and makes a test result report in S307.

In this way, in performing a fault injection test on the electronic control device 300, reliability of the fault injection test may increase by determining whether a fault is normally introduced into the electronic control device 300 and determining whether recovery from the fault is made according to a predefined procedure and standard.

FIG. 4 is a view for explaining how a fault injection testing apparatus creates a test scenario, according to embodiments of the present disclosure.

As shown in FIG. 4, the fault injection testing apparatus 100 may create a test scenario based on setting information of the electronic control device 300 and optional information of the user. FIG. 4 shows a test scenario dialog box displayed on a display of the fault injection testing apparatus 100 to allow the user to input his/her optional information.

The user may input a title and description of a test scenario (P1). The user may also input a test run condition (P2). For example, the test run condition may include a target task to which a fault is to be introduced, a point in time to send the fault data, and a fault data transmission repeat condition. The point in time to send the fault data may be determined according to the number of run times of a predetermined target task or waiting time after the fault injection test is started.

For example, as shown in FIG. 4, the user may select ‘Task_t1’ for the target task, and ‘500’ for the number of running times, and ‘1000’ for the waiting time. In this case, after the lapse of 1000 ms after ‘Task_t1’ is run 500 times, fault data is sent to the electronic control device 300. Furthermore, the user may set a repeat condition to set up repetitive transmission of the fault data. The user may input a gap between repetitive trials and an end value.

Although not shown in FIG. 4, the user may input a variable value so that the fault data may be sent when a variable value of the task of the electronic control device 300 reaches the input variable value.

The user may selectively input a fault inducing method such that a fault may occur according to the selected method (P3). For example, if the user introduces a fault regarding the ‘interruption of task rerun by a scheduler’ among the fault types, the user may select a fault inducing method called ‘task rerun interruption’ to interfere with rerun of the target task by scheduling. In this case, the fault injection testing apparatus 100 creates a test scenario to induce a malfunction of a running task by changing ‘Active count’ value of the task of the electronic control device 300.

Moreover, the user may select other fault type and fault induction method such that a test scenario for introducing the corresponding fault may be created.

The user may also selectively input a fault detection method (P4). The fault detection method conforms to the fault detection standard shown in table 3, and the recovery determination condition conforms to the recovery determination standard shown in table 4. Since there may be many different targets that are influenced by a single fault type, the user may select a target for detection to determine fault detection and recovery. As shown in FIG. 4, if the user selects ‘task run count detection’ for the fault detection method, a corresponding recovery determination condition ‘task run count is incremented again by manipulation of rerun information’ is automatically selected.

Furthermore, the user may set a recovery permission period. If recovery from the injected fault is not made within the recovery permission period, the fault injection testing apparatus 100 may determine that fault recovery is failed. For example, as shown in FIG. 4, the fault injection testing apparatus 100 determines that recovery from the injected fault is normally made if the recovery is made within the recovery permission period ‘1000 ms’ and that the recovery is failed if the recovery is not made within the recovery permission period.

In this way, by creating a test scenario in advance, there is no need to make and insert an extra code for the fault injection test but the test scenario may be reused, thereby improving work efficiency and saving costs.

FIG. 5 shows an example of a fault injection testing apparatus monitoring and outputting a state of an electronic control device, according to embodiments of the present disclosure. In FIG. 5, the fault injection testing apparatus 100 monitoring the task run count value of the electronic control device 300 to determine fault detection and recovery will be described.

As shown in FIG. 5, the fault injection testing apparatus 100 starts monitoring the state of the electronic control device 300 once a fault injection test is started. If a fault data transmission time f1 set in advance in the test scenario is reached during the ongoing test, the fault injection testing apparatus 100 injects a fault to the electronic control device 300 by sending fault data thereto.

The fault injection testing apparatus 100 monitors the state of a task and determines that a fault is detected if the task count is not incremented until a certain time f2 after transmission of the fault data. The fault injection testing apparatus 100 determines that recovery from the fault is made at a particular time f4 if the task run count is incremented again within a recovery permission period f3=f5−f1. If recovery from the fault is not made within the recovery permission period, the fault injection testing apparatus 100 determines that recovery is failed.

FIG. 6 shows an example of a fault injection testing apparatus making a test result report, according to embodiments of the present disclosure.

As shown in FIG. 6, the test result report may include a test title, a test type, a scenario name, a scenario description, a test check type, a test target, a test condition, a test start time, a test finish time, a task-kill tried time, an Electronic Control Unit (ECU) reset estimated time, exceptions, test result summary, a measure result, a monitoring graph, etc.

Especially, the item ‘exceptions’ included in the test result report has information on analysis of state changes output based on state information of the electronic control device 300 before and after transmission of the fault data. The fault injection testing apparatus 100 may provide analysis information on state changes of the electronic control device 300 in the form of a report for the user, thereby eliminating the inconvenience of having to make the report by himself/herself and preventing a mistake that might be made when monitoring is directly performed by the user.

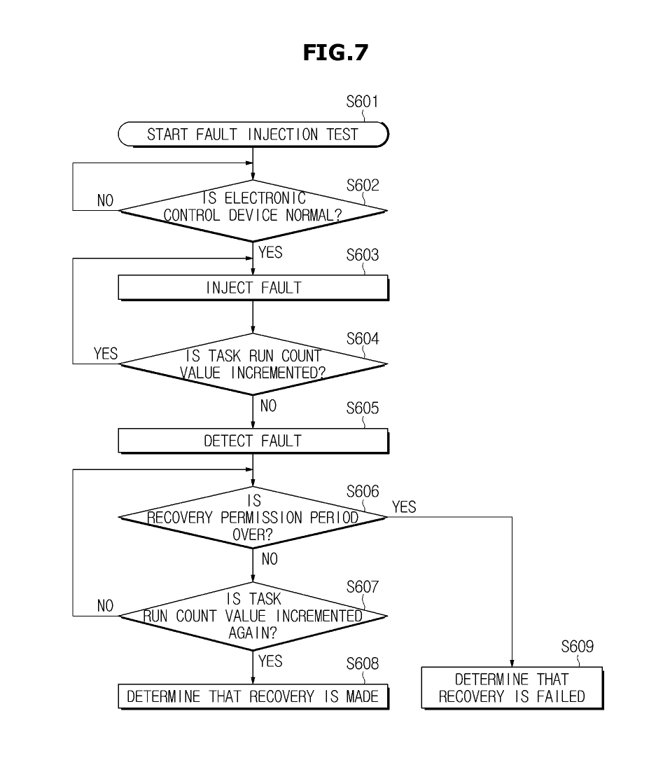

FIGS. 7 to 12 are flowcharts illustrating a fault injection testing method, according to embodiments of the present disclosure.

First, FIG. 7 is a flowchart of a method for determining fault detection and fault recovery by monitoring the task run count value.

As shown in FIG. 7, once a fault injection test is started in S601, the fault injection testing apparatus 100 first starts monitoring the electronic control device 300 to determine whether the electronic control device 300 is in a normal state in S602. It is assumed herein that a test scenario for the fault injection test has already been created.

If it is determined that the electronic control device 300 is in a normal state, the fault injection testing apparatus 100 sends fault data to the electronic control device 300 according to the test scenario, in S603. The fault injection testing apparatus 100 monitors whether the task run count value of the electronic control device 300 is not incremented due to the fault data, in S604, and if the task run count value is not incremented, determines that a fault is detected and the fault data has been normally sent, in S605. If the task run count value continues to be incremented even after transmission of the fault data, it is determined that the fault data has not been correctly sent.

If the task run count value is incremented again within a recovery permission period after the fault is detected, the fault injection testing apparatus 100 determines that recovery from the fault induced by the fault data is normally made, in S606, S607, and S608. Otherwise, if the task run count value is not incremented again within the recovery permission period or if the task run count value is incremented again after the lapse of the recovery permission period, it is determined that recovery is failed, in S609.

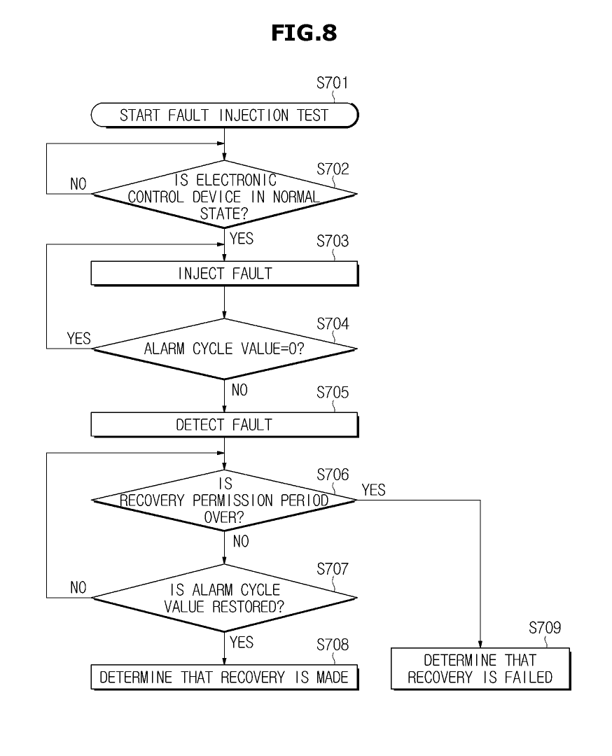

Next, FIG. 8 is a flowchart of a method for determining fault detection and fault recovery by monitoring the alarm cycle value.

As shown in FIG. 8, once a fault injection test is started in S701, the fault injection testing apparatus 100 first starts monitoring the electronic control device 300 to determine whether the electronic control device 300 is in a normal state in S702. It is assumed herein that a test scenario for the fault injection test has already been created.

If it is determined that the electronic control device 300 is in a normal state, the fault injection testing apparatus 100 sends fault data to the electronic control device 300 according to the test scenario, in S703. The fault injection testing apparatus 100 monitors whether the alarm cycle (CYCLE) value of the electronic control device 300 is changed due to the fault data, in S704, and if the alarm cycle value is changed to ‘0’, determines that a fault is detected and the fault data has been normally sent, in S705. If the alarm cycle value is not changed to ‘0’ even after transmission of the fault data, it is determined that the fault data has not been correctly sent.

If the alarm cycle value is changed to a value before the fault data was sent within a recovery permission period after the fault is detected, the fault injection testing apparatus 100 determines that recovery from the fault induced by the fault data is normally made, in S706, S707, and S708. Otherwise if the alarm cycle value is not changed to the value before the fault data was sent within the recovery permission period or is changed to the value before the fault data was sent after the lapse of the recovery permission period, it is determined that recovery is failed, in S709.

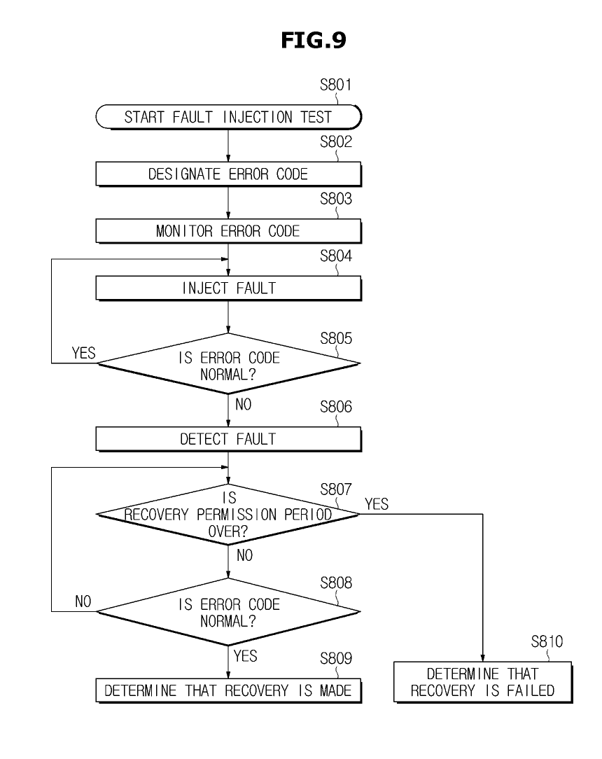

Next, FIG. 9 is a flowchart of a method for determining fault detection and fault recovery by monitoring the error code value.

As shown in FIG. 9, once the fault injection test is started in S801, the fault injection testing apparatus 100 starts monitoring an error code of the electronic control device 100, which is designated when a test scenario is created, in S802 and S803.

If it is determined that the electronic control device 300 is in a normal state, the fault injection testing apparatus 100 sends fault data to the electronic control device 300 according to the test scenario, in S804. The fault injection testing apparatus 100 monitors whether the error code value of the electronic control device 300 is abnormal due to the fault data, in S805, and if the error code value is abnormal, determines that a fault is detected and the fault data has been normally sent, in S806. If the error code value is still normal even after transmission of the fault data, it is determined that the fault data has not been correctly sent.

If the error code value is changed to a value before the fault data was sent within a recovery permission period after the fault is detected, the fault injection testing apparatus 100 determines that recovery from the fault induced by the fault data is normally made, in S807, S808, and S809. Otherwise if the error code value is not changed to the value before the fault data was sent within the recovery permission period or is changed to the value before the fault data was sent after the lapse of the recovery permission period, it is determined that recovery is failed, in S810.

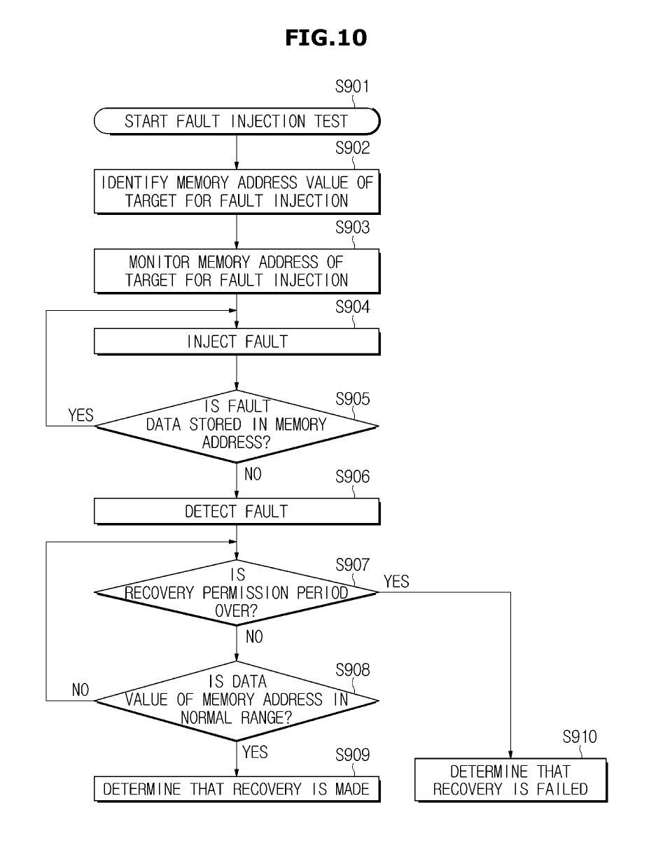

Next, FIG. 10 is a flowchart of a method for determining fault detection and fault recovery by monitoring a memory area.

As shown in FIG. 10, once a fault injection test is started in S901, the fault injection testing apparatus 100 identifies a memory address value of the electronic control device 300 to send fault data to in S902, and starts monitoring the memory address in S903. It is assumed herein that a test scenario for the fault injection test has already been created and the memory address to be monitored has been designated.

If it is determined that the electronic control device 300 is in a normal state, the fault injection testing apparatus 100 sends fault data to the electronic control device 300 according to the test scenario, in S904. The fault injection testing apparatus 100 monitors whether the fault data is stored in the memory address of the electronic control device 300 because the fault data is sent, in S905, and if the fault data value is stored in the memory address, determines that a fault is detected and the fault data has been normally sent, in S906. If the fault data value is not stored in the memory address even after transmission of the fault data, it is determined that the fault data has not been correctly sent.

If a data value in the memory address is changed to a value in a normal range before the fault data was sent within a recovery permission period after the fault is detected, the fault injection testing apparatus 100 determines that recovery from the fault induced by the fault data is normally made, in S907, S908, and S909. Otherwise if the data value in the memory address is not changed to the value before the fault data was sent within the recovery permission period or is changed to the value before the fault data was sent after the lapse of the recovery permission period, it is determined that recovery is failed, in S910.

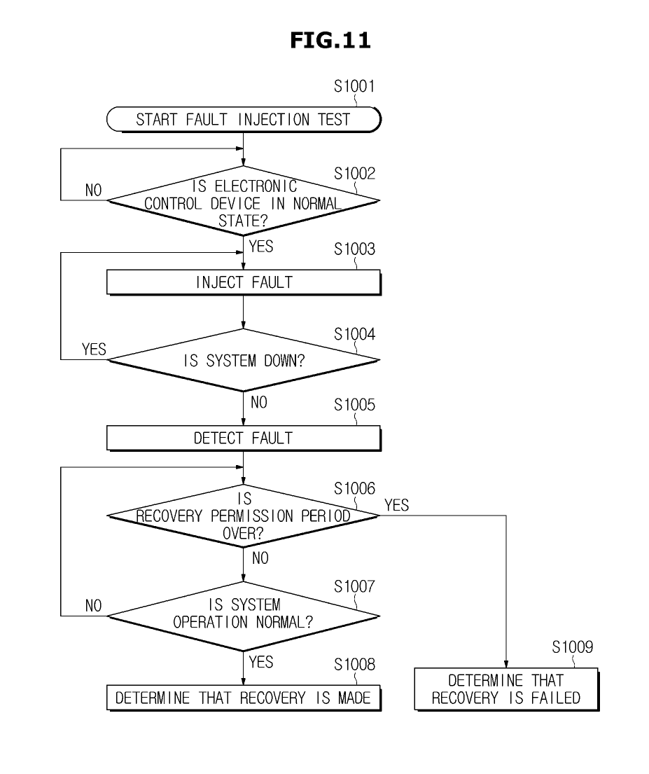

Next, FIG. 11 is a flowchart of a method for determining fault detection and fault recovery by monitoring the entire system operation of the electronic control device.

As shown in FIG. 11, once a fault injection test is started in S1001, the fault injection testing apparatus 100 starts monitoring the electronic control device 300 to determine whether the electronic control device 300 is in a normal state in S1002. It is assumed herein that a test scenario for the fault injection test has already been created.

If it is determined that the electronic control device 300 is in a normal state, the fault injection testing apparatus 100 sends fault data to the electronic control device 300 according to the test scenario, in S1003. The fault injection testing apparatus 100 monitors how the system of the electronic control device 300 operates due to the fault data, in S1004, and if the system is down, causing all the tasks to be frozen, and there is an error occurring in debugger connection, determines that a fault is detected and the fault data has been normally sent, in S1005. Otherwise, if the system of the electronic control device 300 is normally operating with all the tasks operating normally and no error occurs in the debugger connection even after the fault data is sent, it is determined that the fault data has not been correctly sent.

If the system of the electronic control device 300 normally operates again within a recovery permission period after the fault is detected, the fault injection testing apparatus 100 determines that recovery from the fault induced by the fault data is normally made, in S1006, S1007, and S1008. Otherwise, if the system does not normally operate again within the recovery permission period or if the system normally operates again after the lapse of the recovery permission period, it is determined that recovery is failed, in S1009.

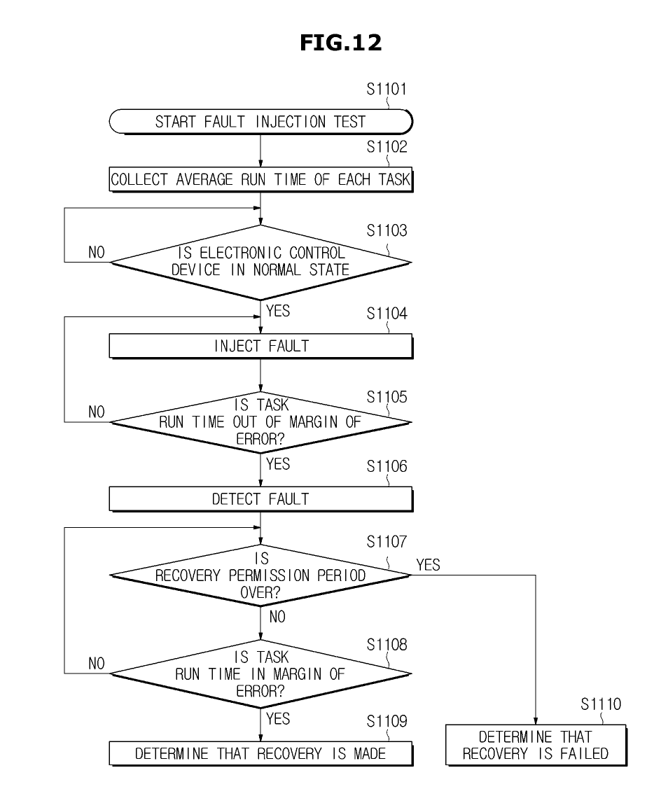

Next, FIG. 12 is a flowchart of a method for determining fault detection and fault recovery by monitoring the task run time of the electronic control device.

As shown in FIG. 12, once a fault injection test is started in S1101, the fault injection testing apparatus 100 starts monitoring the electronic control device 300 to determine whether the electronic control device 300 is in a normal state in S1103. It is assumed herein that a test scenario for the fault injection test has already been created and an average run time of each task has been collected, in S1102.

If it is determined that the electronic control device 300 is in a normal state, the fault injection testing apparatus 100 sends fault data to the electronic control device 300 according to the test scenario, in S1104. The fault injection testing apparatus 100 monitors how the fault data influences the task run time of the electronic control device 300, in S1105, and if the task run time measured is out of the margin of error of the average task run time, determines that a fault is detected and the fault data has been normally sent, in S1106. Otherwise, if the task run time of the electronic control device 300 is measured in the margin of error of the average task run time even after the fault data is sent, it is determined that the fault data has not been correctly sent.

If the task run time of the electronic control device 300 is measured back in the margin of error of the average task run time within a recovery permission period after the fault is detected, the fault injection testing apparatus 100 determines that recovery from the fault induced by the fault data is normally made, in S1107, S1108, and S1109. Otherwise, if the task run time of the electronic control device 300 is not measured in the margin of error of the average task run time within the recovery permission period, or if the task run time is measured in the margin of error of the average task run time after the lapse of the recovery permission period, it is determined that recovery is failed, in S1110.

According to the embodiments of the present disclosure, a fault injection testing apparatus and method may increase reliability of a fault injection test by determining whether a fault is normally introduced into an electronic control device for the fault injection test and determining whether recovery from the fault is made based on a predefined procedure and reference. Furthermore, a fault injection testing apparatus and method may automatize the fault injection test, thereby increasing work efficiency and saving costs for performing the test.

According to embodiments of the present disclosure, a fault injection testing apparatus and method may enable an infrastructure to be built to perform a fault injection test not only on an unfixed electronic control device but also on an electronic control device connected to a vehicle driving simulation tool, e.g., HIL, or to a vehicle. Further, according to embodiments of the present disclosure, a fault injection testing apparatus and method eliminates a need to make and insert an extra code for the fault injection test. Even further, according to embodiments of the present disclosure, a fault injection testing apparatus and method may allow a preemptive counterstrategy to be devised for a process of an electronic control device before the vehicle is produced.

Meanwhile, the embodiments of the present disclosure may be implemented in the form of recording media for storing instructions to be carried out by a computer. The instructions may be stored in the form of program codes, and when executed by a processor, may generate program modules to perform operation in the embodiments of the present disclosure. The recording media may correspond to computer-readable recording media.

The computer-readable recording medium includes any type of recording medium having data stored thereon that may be thereafter read by a computer. For example, it may be a ROM, a RAM, a magnetic tape, a magnetic disk, a flash memory, an optical data storage device, etc.

Several embodiments have been described above, but a person of ordinary skill in the art will understand and appreciate that various modifications can be made without departing the scope of the present disclosure. Thus, it will be apparent to those ordinary skilled in the art that the true scope of technical protection is only defined by the following claims.

What is claimed is:

1. A fault injection testing apparatus comprising:
a communication module communicating with an electronic control device;
a test scenario management module creating a test scenario for performing a fault injection test on the electronic control device;
a test run module running the fault injection test according to the test scenario and transmitting fault data to the electronic control device;
a fault detection module determining whether the fault data is normally transmitted to the electronic control device from the test run module; and
a recovery determination module determining whether the electronic control device recovers from a fault introduced to the electronic control device through the fault data transmitted from the test run module.

2. The fault injection testing apparatus of claim 1, further comprising: a monitoring module monitoring a state of the electronic control device when the fault injection test is started.

3. The fault injection testing apparatus of claim 1, further comprising: a report making module making a test result report, when the fault injection test is completed, including state information of the electronic control device and analysis information about a change in a state of the electronic control device before and after the transmission of the fault data.

4. The fault injection testing apparatus of claim 1, wherein the test scenario comprises a test run condition, the fault data to be transmitted to the electronic control device, a fault detection standard, and a recovery determination standard.

5. The fault injection testing apparatus of claim 4, wherein the test run condition comprises a target task to which a fault is to be introduced, a point in time to transmit the fault data, and a fault data transmission repeat condition.

6. The fault injection testing apparatus of claim 4, wherein the fault data corresponds to a fault type among a plurality of predetermined fault types comprising task run interruption, prevention of task rerun by a scheduler, prevention of task rerun through interruption of alarming, prevention of task rerun after waiting for an event, prevention of task rerun by inducing deadlock while waiting for a resource, prevention of task rerun by inducing stack overflow, task overrun, variable value contamination, code change, CPU register value contamination, software component contamination, and a bit flip.

7. The fault injection testing apparatus of claim 4, wherein the fault detection module determines that the fault data is normally transmitted when the fault is detected based on a fault detection standard that determines whether the fault affects at least one of a task run count value, an alarm cycle value, an error code value, a data value of a particular memory area, an entire system operation, and a task running time.

8. The fault injection testing apparatus of claim 4, wherein the recovery determination module determines whether the electronic control device recovers from the fault based on a recovery determination standard that determines whether the electronic control device recovers from the fault affecting at least one of a task run count value, an alarm cycle value, an error code value, a data value of a particular memory area, an entire system operation, and a task running time is made.

9. The fault injection testing apparatus of claim 2, wherein the monitoring module outputs a graph indicating changes in a task state and a graph indicating changes in a variable value of the electronic control device, resulting from a fault injection test run.

10. The fault injection testing apparatus of claim 1, wherein the test scenario management module creates a test scenario to suit characteristics of the electronic control device based on setting information of the electronic control device received through the communication module.

11. The fault injection testing apparatus of claim 5, wherein the point in time to transmit fault data is determined according to a number of times a predetermined target task is run or a waiting time after the fault injection test has started.

12. The fault injection testing apparatus of claim 1, wherein the recovery determination module determines that the electronic control device fails to recover from the fault when recovery from the fault is not made within a recovery permission period.

13. A fault injection testing method comprising:
establishing a communication session with an electronic control devices using a communication module;
receiving design information of the electronic control device via the established communication session;
creating a test scenario for performing a fault injection test on the electronic control device;
running the fault injection test according to the test scenario;
transmitting fault data to the electronic control device;
determining whether the fault data is normally transmitted to the electronic control device; and
determining whether the electronic control device recovers from a fault introduced to the electronic control device through the transmitted fault data.

14. The fault injection testing method of claim 13, further comprising:
monitoring a state of the electronic control device when the fault injection test is started.

15. The fault injection testing method of claim 13, further comprising:
when the fault injection test is completed, making a test result report including state information of the electronic control device and analysis information about a change in a state of the electronic control device before and after the transmission of the fault data.

16. The fault injection testing method of claim 13, wherein the test scenario comprises a test run condition, the fault data to be transmitted to the electronic control device, a fault detection standard, and a recovery determination standard.

17. The fault injection testing method of claim 16, wherein the test run condition comprises a target task to which a fault is to be introduced, a point in time to transmit the fault data, and a fault data transmission repeat condition.

18. The fault injection testing method of claim 16, wherein the fault data corresponds to a fault type among a plurality of predetermined fault types comprising task run interruption, prevention of task rerun by a scheduler, prevention of task rerun through interruption of alarming, prevention of task rerun after waiting for an event, prevention of task rerun by inducing deadlock while waiting for a resource, prevention of task rerun by inducing stack overflow, task overrun, variable value contamination, code change, CPU register value contamination, software component contamination, and a bit flip.

19. The fault injection testing method of claim 17, wherein the determining of whether the fault data is normally transmitted comprises:
determining that fault data is normally transmitted when the fault fault is detected based on a fault detection standard that determines whether the fault affects at least one of a task run count value, an alarm cycle value, an error code value, a data value of a particular memory area, an entire system operation and a task running time.

20. The fault injection testing method of claim 17, wherein the determining of whether the electronic control device recovers from the fault comprises:
determining whether the electronic control device recovers from the fault based on a recovery determination standard that determines whether the electronic control device recovers from the fault affecting at least one of a task run count value, an alarm cycle value, an error code value, a data value of a particular memory area, an entire system operation and a task running time.
